(19) United States
(12) Patent Application Publication
(10) Pub. No.: US 2026/0116118 A1
(43) Pub. Date: Apr. 30, 2026

(54) PLUG STRUCTURE, LIQUID CARTRIDGE, AND PEN

(71) Applicant: LION PENCIL CO., LTD., New Taipei City (TW)

(72) Inventor: Hung-Jen CHANG, New Taipei City (TW)

(21) Appl. No.: 19/004,427

(22) Filed: Dec. 29, 2024

(30) Foreign Application Priority Data
Jan. 5, 2024 (TW) 113100626

(51) Int. Cl. B43K 5/14

(52) U.S. Cl. CPC B43K 5/145

(57) ABSTRACT

A pen includes a pen tube, a liquid guide accommodated in the pen tube, a tail sleeve detachably connected to the pen tube, and a liquid cartridge. The liquid cartridge is accommodated in the tail sleeve and extends into the pen tube. The liquid cartridge includes a container and a plug structure. The container has an opening. The plug structure is disposed in the container and includes a cover portion, an elastic connection portion, and an annular wall portion. The elastic connection portion is connected to the cover portion and has a hollow portion. The annular wall portion is connected to the elastic connection portion and surrounds the cover portion. An annular gap is formed between the cover portion and the annular wall portion and communicated with the hollow portion. The liquid guide is pressed against the cover portion to open the annular gap.

### CROSS-REFERENCE TO RELATED APPLICATION

This application claims priority to Taiwan Application Serial Number 113100626, filed Jan. 5, 2024, which is herein incorporated by reference.

### BACKGROUND

### Technical Field

The present disclosure relates to a plug structure, a liquid cartridge, and a pen.

### Description of Related Art

A direct-feed pen has a liquid cartridge inside to store ink. When writing, a pen tip is pressed to open a valve, allowing the ink in the liquid cartridge to be drawn through the valve to a liquid supply body and supplied to the pen tip, thereby providing ink for writing. The conventional liquid supply body is usually a sponge sleeve, which is placed outside the pen tip. The sponge sleeve communicates with an ink chamber through the valve, absorbs the ink in the ink chamber, and then supplies it to the pen tip for writing.

However, when the ink is used up and the liquid cartridge needs to be replaced, an opening of the conventional liquid cartridge does not have a sealing structure, so liquid leakage may easily occur when taking it out. If the liquid leakage is not desired, the liquid cartridge needs to be taken out with the opening facing upwards, which will only increase the inconvenience for the user when replacing the liquid cartridge.

Accordingly, how to provide a plug structure, a liquid cartridge, and a pen to solve the aforementioned problems becomes an important issue to be solved by those in the industry.

### SUMMARY

An aspect of the disclosure is to provide a plug structure, a liquid cartridge, and a pen that can efficiently solve the aforementioned problems.

According to an embodiment of the disclosure, a plug structure includes a cover portion, an elastic connection portion, and an annular wall portion. The elastic connection portion is connected to the cover portion and has at least one hollow portion. The annular wall portion is connected to the elastic connection portion and surrounds the cover portion. An annular gap is formed between a side surface of the cover portion and the annular wall portion and communicated with the at least one hollow portion. The annular wall portion is configured to abut against the side surface to seal the annular gap.

In an embodiment of the disclosure, the annular wall portion has at least one annular flange. The at least one annular flange is located on an inner wall surface of the annular wall portion. The annular wall portion is configured to abut against the side surface of the cover portion by using the at least one annular flange.

In an embodiment of the disclosure, the cover portion is configured to be pressed to make the elastic connection portion deform, so as to separate the at least one annular flange and the side surface of the cover portion to open the annular gap.

In an embodiment of the disclosure, a number of the at least one hollow portion is a plural number. The elastic connection portion includes a plurality of connecting pillars. Two ends of each of the connecting pillars are respectively connected to the cover portion and the annular wall portion. The connecting pillars and the hollow portions are arranged alternately in an annular manner.

In an embodiment of the disclosure, the elastic connection portion includes an engaging plate. The engaging plate is engaged with a bottom surface of the cover portion.

In an embodiment of the disclosure, the elastic connection portion and the annular wall portion form a unitary structure.

In an embodiment of the disclosure, a hardness of the cover portion is greater than a hardness of the annular wall portion.

According to an embodiment of the disclosure, a liquid cartridge includes a container and a plug structure. The container has an opening. The plug structure is disposed in the container and includes a cover portion, an elastic connection portion, and an annular wall portion. The elastic connection portion is connected to the cover portion on a side of the cover portion away from the opening, and has at least one hollow portion. The annular wall portion is connected to the elastic connection portion and surrounds the cover portion. An annular gap is formed between a side surface of the cover portion and the annular wall portion and communicated with the at least one hollow portion. The annular wall portion is clamped between an inner tube surface of the container and the side surface of the cover portion, so as to make the annular gap seal.

In an embodiment of the disclosure, the annular wall portion has at least one annular flange. The at least one annular flange is located on an outer wall surface of the annular wall portion and abuts against the inner tube surface of the container.

In an embodiment of the disclosure, the inner tube surface of the container has an inwardly retracted step portion. The plug structure is engaged with the inwardly retracted step portion.

In an embodiment of the disclosure, a diameter of the container tapers from the opening toward the inwardly retracted step portion.

According to an embodiment of the disclosure, a pen includes a pen tube, a liquid guide, a tail sleeve, and a liquid cartridge. The liquid guide is accommodated in the pen tube. The tail sleeve is detachably connected to the pen tube. The liquid cartridge is accommodated in the tail sleeve and extends into the pen tube. The liquid cartridge includes a container and a plug structure. The container has an opening. The plug structure is disposed in the container and includes a cover portion, an elastic connection portion, and an annular wall portion. The elastic connection portion is connected to the cover portion on a side of the cover portion away from the opening, and has at least one hollow portion. The annular wall portion is connected to the elastic connection portion and surrounds the cover portion. An annular gap is formed between a side surface of the cover portion and the annular wall portion and communicated with the at least one hollow portion. The liquid guide presses against the cover portion to make the annular gap open.

Accordingly, in the plug structure of the present disclosure, the cover portion and the annular wall portion are connected through an elastic connection portion. When the plug structure is installed in the container of the liquid cartridge, the annular gap formed between the side surface of the cover portion and the annular wall portion will be clamped between the inner tube surface of the container and the side surface of the cover portion, so as to make the annular gap seal. When the liquid cartridge is installed in the pen, the liquid guide of the pen presses against the cover portion and elastically deforms the elastic connection portion to make the annular gap open, thereby allowing the liquid in the liquid cartridge to flow to the pen tip through the plug structure for writing. When the liquid cartridge is taken out from the pen, the liquid guide will be separated from the cover portion, so as to make the elastic connection portion elastically recover and make the annular gap in a sealed state. In this way, liquid leakage problems can be effectively avoided when replacing the liquid cartridge.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a direct-feed pen according to an embodiment of the disclosure;

FIG. 2 is an exploded view of the direct-feed pen in FIG. 1;

FIG. 3 is a perspective cross-sectional view of a plug structure in FIG. 2;

FIG. 4 is a perspective cross-sectional view of a liquid cartridge in FIG. 2;

FIG. 5 is a cross-sectional view of the direct-feed pen in FIG. 1;

FIG. 6 is an enlarged view of FIG. 5; and

FIG. 7 is another enlarged view of FIG. 5.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

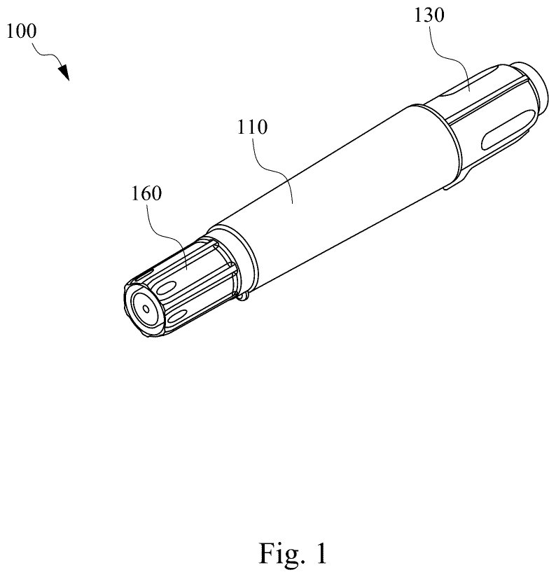

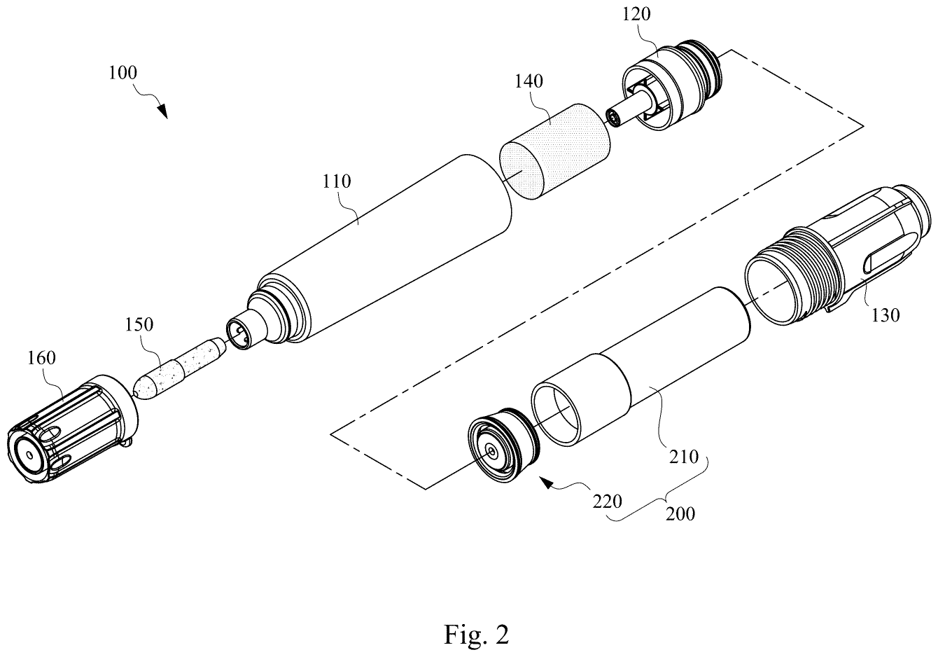

Reference is made to FIGS. 1 and 2. FIG. 1 is a perspective view of a direct-feed pen 100 according to an embodiment of the disclosure. FIG. 2 is an exploded view of the direct-feed pen 100 in FIG. 1. As shown in FIGS. 1 and 2, the direct-feed pen 100 includes a pen tube 110, a liquid guide 120, a tail sleeve 130, a liquid cartridge 200, a liquid supply body 140, a pen tip 150, and a pen cap 160. The liquid guide 120 is accommodated in the pen tube 110. The tail sleeve 130 is detachably connected to the pen tube 110. The liquid cartridge 200 is accommodated in the tail sleeve 130 and extends into the pen tube 110. The liquid cartridge 200 is configured to contain liquid (e.g., ink, paint, etc.). The liquid supply body 140 is accommodated in the pen tube 110 and is located on a side of the liquid guide 120 away from the liquid cartridge 200. The liquid guide 120 is configured to guide the liquid in the liquid cartridge 200 to the liquid supply body 140. The pen tip 150 is disposed at an end of the pen tube 110 away from the tail sleeve 130 and penetrates into the pen tube 110 to be in fluid communication with the liquid supply body 140. The liquid supply body 140 is configured to absorb the liquid in the liquid cartridge 200 and evenly distribute the liquid therein, so that the liquid can be uniformly provided to the pen tip 150. The pen cap 160 is configured to be detachably connected to an end of the pen tube 110 away from the tail sleeve 130 to cover the pen tip 150 without exposing it.

In some embodiments, the liquid supply body 140 is foam, but the present disclosure is not limited thereto.

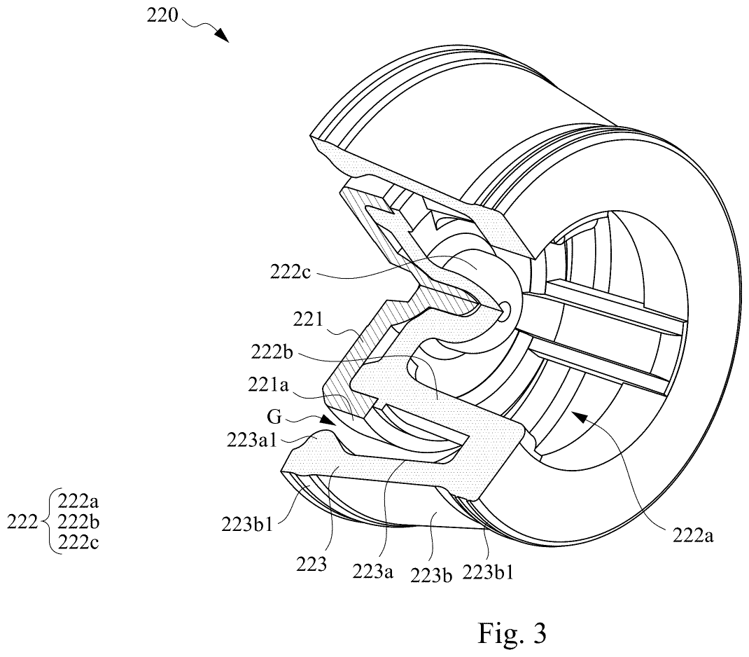

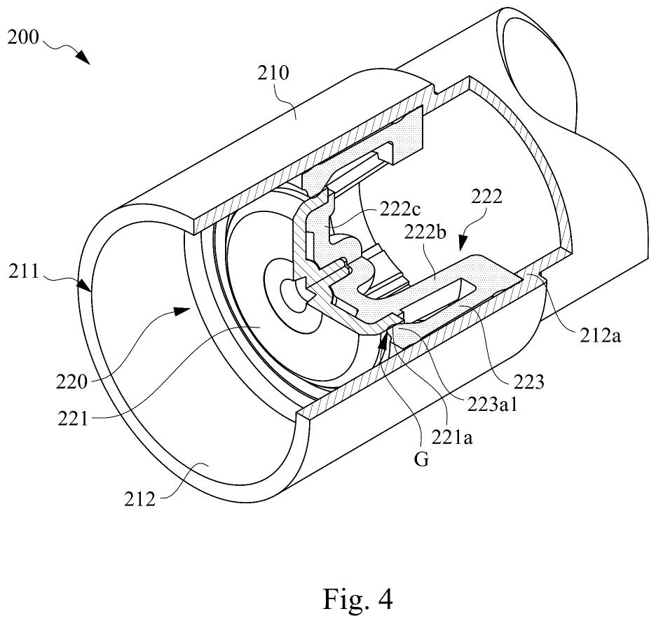

Reference is made to FIGS. 3 and 4. FIG. 3 is a perspective cross-sectional view of a plug structure 220 in FIG. 2. FIG. 4 is a perspective cross-sectional view of the liquid cartridge 200 in FIG. 2. As shown in FIGS. 2 to 4, in the present embodiment, the liquid cartridge 200 includes a container 210 and the plug structure 220. The container 210 has an opening 211. The opening 211 faces the liquid guide 120. The plug structure 220 is disposed in the container 210 and includes a cover portion 221, an elastic connection portion 222, and an annular wall portion 223. The elastic connection portion 222 is connected to the cover portion 221 on a side of the cover portion 221 away from the opening 211, and has at least one hollow portion 222a. The annular wall portion 223 is connected to the elastic connection portion 222 and surrounds the cover portion 221. An annular gap G is formed between a side surface 221a of the cover portion 221 and the annular wall portion 223 and communicated with the hollow portion 222a of the elastic connection portion 222. The annular wall portion 223 is configured to abut against the side surface 221a of the cover portion 221 to seal the annular gap G.

In detail, as shown in FIG. 4, the annular wall portion 223 of the plug structure 220 is clamped between an inner tube surface 212 of the container 210 and the side surface 221a of the cover portion 221, so as to make the annular gap G seal. At this time, the liquid accommodated in the container 210 will not be able to pass through the plug structure 220 and flow out from the opening 211 of the container 210. In contrast, as shown in FIG. 3, when the plug structure 220 is not disposed in the container 210, the annular wall portion 223 that is not pressed and is in a natural state will separate from the cover portion 221, so as to make the annular gap G open.

As shown in FIGS. 3 and 4, in the present embodiment, the annular wall portion 223 has an annular flange 223a1. The annular flange 223a1 is located on an inner wall surface 223a of the annular wall portion 223. The annular wall portion 223 is configured to abut against the side surface 221a of the cover portion 221 by using the annular flange 223a1. Through the design of the annular flange 223a1, the contact area between the annular wall portion 223 and the cover portion 221 can be reduced and concentrated, and the contact pressure of the contact area can be increased, thereby improving the airtight effect.

In some embodiments, in order to further improve the airtight effect between the annular wall portion 223 and the cover portion 221, a hardness of the cover portion 221 is greater than a hardness of the annular wall portion 223. Since the harder cover portion 221 is not easily deformed when abutted against by the soft annular wall portion 223, incomplete sealing of the annular gap G can be effectively avoided.

In some embodiments, the cover portion 221 is made of a hard material, such as metal or a hard plastic material, but the present disclosure is not limited thereto. In some embodiments, the annular wall portion 223 is made of a soft material, such as a soft plastic material or rubber, but the disclosure is not limited thereto.

As shown in FIGS. 3 and 4, in the present embodiment, a number of the at least one hollow portion 222a of the elastic connection portion 222 is a plural number. The elastic connection portion 222 includes a plurality of connecting pillars 222b. Two ends of each of the connecting pillars 222b are respectively connected to the cover portion 332 and the annular wall portion 223. The connecting pillars 222b and the hollow portions 222a are arranged alternately in an annular manner.

As shown in FIGS. 3 and 4, in the present embodiment, the number of hollow portions 222a and a number of connecting pillars 222b of the elastic connection portion 222 are both three, but the disclosure is not limited thereto. In practical applications, the number of hollow portions 222a and the number of connecting pillars 222b can be flexibly increased or decreased according to the required elasticity of the elastic connection portion 222.

As shown in FIGS. 3 and 4, in the present embodiment, the elastic connection portion 222 further includes an engaging plate 222c. An identical end of each of the connecting pillars 222b is connected to the engaging plate 222c. The engaging plate 222c is engaged with a bottom surface of the cover portion 221. In this way, the elastic connection portion 222 can be more firmly connected to the cover portion 221.

In some embodiments, the elastic connection portion 222 and the annular wall portion 223 form a unitary structure. In other words, the elastic connection portion 222 and the annular wall portion 223 can be made of the same or different materials through, for example, an injection molding process. In this way, only the cover portion 221 and the elastic connection portion 222 are connected to complete the assembly of the plug structure 220.

In practical applications, the cover portion 221, the elastic connection portion 222, and the annular wall portion 223 can also form a unitary structure. In other words, the cover portion 221, the elastic connection portion 222, and the annular wall portion 223 can be made of the same or different materials through, for example, an injection molding process. At this time, the aforementioned engaging plate 222c of the elastic connection portion 222 can be omitted.

In some embodiments, the inner tube surface 212 of the container 210 has an inwardly retracted step portion 212a. The plug structure 220 is engaged with the inwardly retracted step portion 212a. During assembly, the plug structure 220 can be put into the opening 211 of the container 210 and continue to move inward until it is engaged with the inwardly retracted step portion 212a. It can be seen from this that the inwardly retracted step portion 212a can achieve the function of positioning the plug structure 220.

In some embodiments, a diameter of the container 210 tapers from the opening 211 toward the inwardly retracted step portion 212a. Therefore, when the plug structure 220 continues to move inward from the opening 211 of the container 210 to the inwardly retracted step portion 212a, the annular wall portion 223 will gradually be pushed toward the cover portion 221 by the inner tube surface 212 of the container 210, thereby continuously increasing the airtightness of the annular gap G.

As shown in FIG. 3 with reference to FIG. 4, in the present embodiment, the annular wall portion 223 of the plug structure 220 further has at least one annular flange 223b1. The annular flange 223b1 is located on an outer wall surface 223b of the annular wall portion 223 and abuts against the inner tube surface 212 of the container 210. The annular wall portion 223 is configured to abut against the inner tube surface 212 of the container 210 by using the annular flange 223b1. Through the design of the annular flange 223b1, the contact area between the annular wall portion 223 and the container 210 can be reduced and concentrated, and the contact pressure of the contact area can be increased, thereby improving the airtight effect. Moreover, since the annular wall portion 223 mainly contacts the inner tube surface 212 of the container 210 by using the annular flange 223b1 (not an entirety of the outer wall surface 223b), the plug structure 220 has less resistance during the continuous inward movement from the opening 211 of the container 210 to the inwardly retracted step portion 212a. In other words, through the design of the annular flange 223b1, the plug structure 220 can have the advantage of being easily installed in the container 210 and improving the airtightness between the plug structure 220 and the container 210.

As shown in FIG. 3, in the present embodiment, a number of annular flanges 223b1 is three, in which one of the annular flanges 223b1 is close to the top of the outer wall surface 223b and is opposite to the annular flange 223a1 inside and outside, while the other two of the annular flanges 223b1 are adjacent to each other and close to the bottom of the outer wall surface 223b. However, the number of annular flanges 223b1 is not limited to the embodiment shown in FIG. 3. In practical applications, the number of annular flanges 223b1 can be flexibly increased or decreased according to the required air tightness.

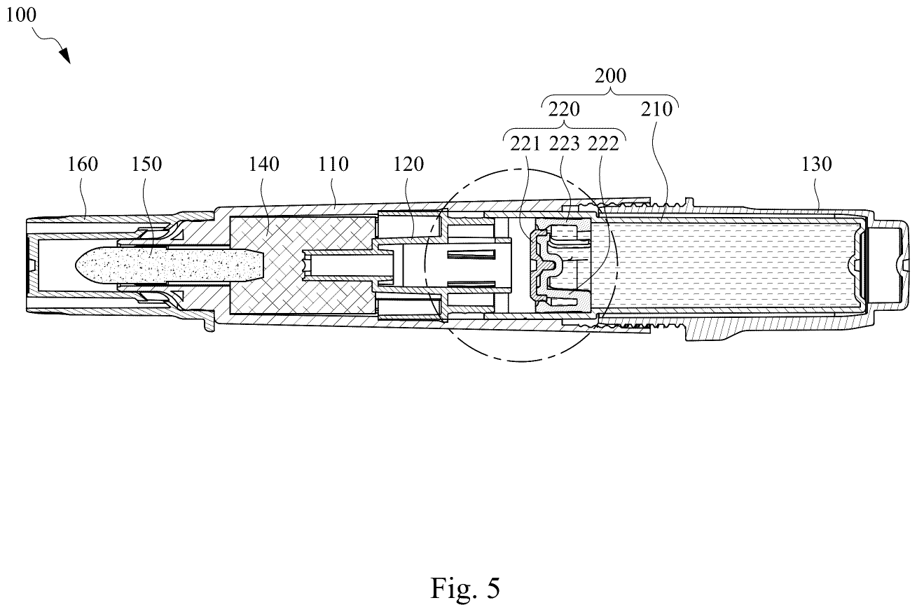

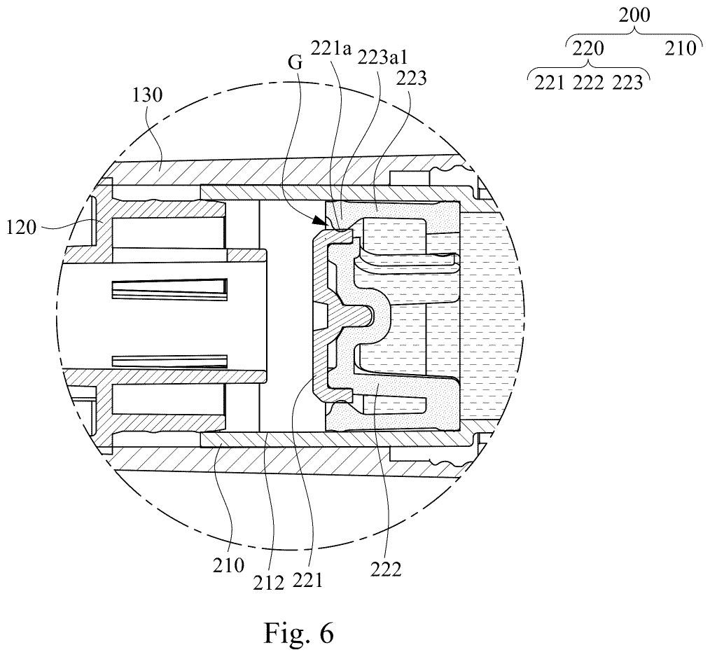

Reference is made to FIGS. 5 and 6. FIG. 5 is a cross-sectional view of the direct-feed pen 100 in FIG. 1. FIG. 6 is an enlarged view of FIG. 5. As shown in FIGS. 5 and 6, in the present embodiment, the tail sleeve 130 has not yet been completely assembled with the pen tube 110. Specifically, the tail sleeve 130 and the pen tube 110 are screwed to each other through threaded structures. At this time, the liquid guide 120 does not contact the plug structure 220, so the annular wall portion 223 clamped between the inner tube surface 212 of the container 210 and the side surface 221a of the cover portion 221 is firmly in contact with the cover portion 221, so as to make the annular gap G seal.

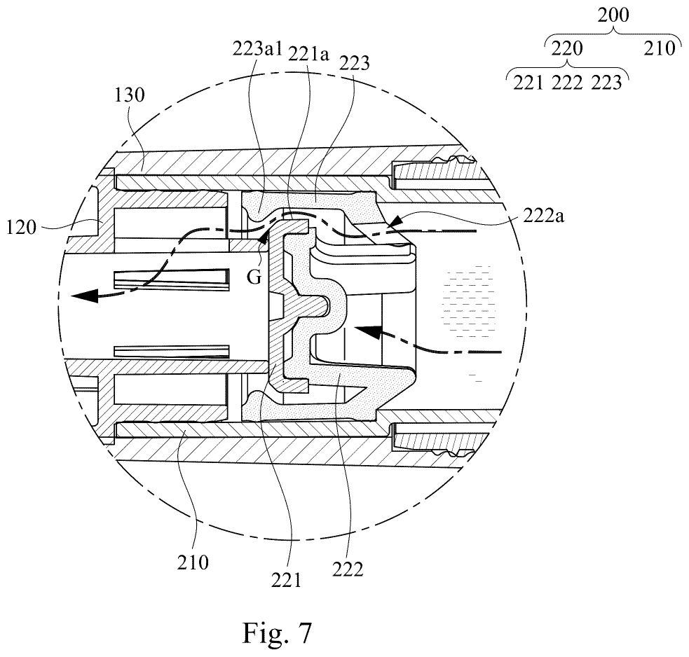

Reference is made to FIG. 7. FIG. 7 is another enlarged view of FIG. 5. As shown in FIG. 7, in the present embodiment, when the tail sleeve 130 and the pen tube 110 continue to be screwed toward each other and are completely assembled, the liquid guide 120 will push against the cover portion 221 of the plug structure 220. The pressed cover portion 221 will deform the elastic connection portion 222, thereby causing the annular flange 223a1 of the annular wall portion 223 to separate from the side surface 221a of the cover portion 221 to open the annular gap G. At this time, the liquid accommodated in the container 210 can flow out to the liquid guide 120 sequentially through the hollow portions 222a of the elastic connection portion 222 and the annular gap G (as the path indicated by the thick arrow in FIG. 7). It can be seen from this that when the liquid cartridge 200 is installed in the direct-feed pen 100, the liquid guide 120 of the direct-feed pen 100 presses against the cover portion 221 and makes the elastic connection portion 222 elastically deform to make the annular gap G open, thereby allowing the liquid in the liquid cartridge 200 to flow to the pen tip 150 through the plug structure 220 for writing.

In contrast, when the liquid in the container 210 is used up and needs to be replaced with a new liquid cartridge 200, the tail sleeve 130 and the pen tube 110 can be moved in opposite directions relative to each other and separated. During this period, the liquid guide 120 will gradually move away from the plug structure 220 and separate from the cover portion 221, causing the elastic connection portion 222 to elastically recover and the cover portion 221 to return to the state of abutting against the annular flange 223a1 of the annular wall portion 223, thereby sealing the annular gap G. In this way, when the liquid cartridge 200 is taken out from the direct-feed pen 100, the remaining liquid in the liquid cartridge 200 will not leak through the plug structure 220.

According to the foregoing recitations of the embodiments of the disclosure, it can be seen that in the plug structure of the present disclosure, the cover portion and the annular wall portion are connected through an elastic connection portion. When the plug structure is installed in the container of the liquid cartridge, the annular gap formed between the side surface of the cover portion and the annular wall portion will be clamped between the inner tube surface of the container and the side surface of the cover portion, so as to make the annular gap seal. When the liquid cartridge is installed in the pen, the liquid guide of the pen presses against the cover portion and elastically deforms the elastic connection portion to make the annular gap open, thereby allowing the liquid in the liquid cartridge to flow to the pen tip through the plug structure for writing. When the liquid cartridge is taken out from the pen, the liquid guide will be separated from the cover portion, so as to make the elastic connection portion elastically recover and make the annular gap in a sealed state. In this way, liquid leakage problems can be effectively avoided when replacing the liquid cartridge.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A plug structure, comprising:
a cover portion;
an elastic connection portion connected to the cover portion and having at least one hollow portion; and
an annular wall portion connected to the elastic connection portion, the annular wall portion being connected to the cover portion through the elastic connection portion and surrounding the cover portion, wherein an annular gap is formed between a side surface of the cover portion and the annular wall portion and communicated with the at least one hollow portion, and the annular wall portion is configured to abut against the side surface to seal the annular gap.

2. The plug structure of claim 1, wherein the annular wall portion has at least one annular flange, the at least one annular flange is located on an inner wall surface of the annular wall portion, and the annular wall portion is configured to abut against the side surface of the cover portion by using the at least one annular flange.

3. The plug structure of claim 2, wherein the cover portion is configured to be pressed to make the elastic connection portion deform, so as to separate the at least one annular flange and the side surface of the cover portion to open the annular gap.

4. The plug structure of claim 1, wherein a number of the at least one hollow portion is a plural number, the elastic connection portion comprises a plurality of connecting pillars, two ends of each of the connecting pillars are respectively connected to the cover portion and the annular wall portion, and the connecting pillars and the hollow portions are arranged alternately in an annular manner.

5. The plug structure of claim 1, wherein the elastic connection portion comprises an engaging plate, and the engaging plate is engaged with a bottom surface of the cover portion.

6. The plug structure of claim 1, wherein the elastic connection portion and the annular wall portion form a unitary structure.

7. The plug structure of claim 1, wherein the cover portion, the elastic connection portion, and the annular wall portion form a unitary structure.

8. The plug structure of claim 1, wherein a hardness of the cover portion is greater than a hardness of the annular wall portion.

9. A liquid cartridge, comprising:
a container having an opening; and
a plug structure disposed in the container and comprising:
a cover portion;
an elastic connection portion connected to the cover portion on a side of the cover portion away from the opening, and having at least one hollow portion; and
an annular wall portion connected to the elastic connection portion, the annular wall portion being connected to the cover portion through the elastic connection portion and surrounding the cover portion, wherein an annular gap is formed between a side surface of the cover portion and the annular wall portion and communicated with the at least one hollow portion, and the annular wall portion is clamped between an inner tube surface of the container and the side surface of the cover portion, so as to make the annular gap seal.

10. The liquid cartridge of claim 9, wherein the annular wall portion has at least one annular flange, and the at least one annular flange is located on an outer wall surface of the annular wall portion and abuts against the inner tube surface of the container.

11. The liquid cartridge of claim 9, wherein the annular wall portion has two annular flanges located on an outer wall surface of the annular wall portion, one of the annular flanges is close to a top of the outer wall surface, and another of the annular flanges is close to a bottom of the outer wall surface.

12. The liquid cartridge of claim 9, wherein the annular wall portion has two annular flanges respectively located on an inner wall surface and an outer wall surface of the annular wall portion, and the two annular flanges are opposite to each other inside and outside.

13. The liquid cartridge of claim 9, wherein the inner tube surface of the container has an inwardly retracted step portion, and the plug structure is engaged with the inwardly retracted step portion.

14. (canceled)

15. A pen, comprising:
a pen tube;
a liquid guide accommodated in the pen tube;
a tail sleeve detachably connected to the pen tube; and
a liquid cartridge accommodated in the tail sleeve and extending into the pen tube, the liquid cartridge comprising a container and a plug structure, the container having an opening, the plug structure being disposed in the container and comprising:
a cover portion;
an elastic connection portion connected to the cover portion on a side of the cover portion away from the opening, and having at least one hollow portion; and
an annular wall portion connected to the elastic connection portion, the annular wall portion being connected to the cover portion through the elastic connection portion and surrounding the cover portion, wherein an annular gap is formed between a side surface of the cover portion and the annular wall portion and communicated with the at least one hollow portion, and the liquid guide is pressed against the cover portion, so as to make the annular gap open.
